(19) United States
(12) Patent Application Publication
(10) Pub. No.: US 2007/0023725 A1
(43) Pub. Date: Feb. 1, 2007

(54) Retention valve which controls the emptying of cylinders with liquid petroleum gas

(76) Inventors: Luis Guillermo B. Sepulveda, Santiago (CL); Rodolfo Enrique T. Sepulveda, Santiago (CL)

Correspondence Address: Finnegan, Henderson, Farabow;Garrett & Dunner, L.L.P., 901 New York Avenue, N.W., Washington, DC, 20005-3315, US

(21) Appl. No.: 11/453,257

(22) Filed: Jun. 15, 2006

Related U.S. Application Data
(63) Continuation of application No. 10/926,343, filed on Aug. 26, 2004, now abandoned.

(30) Foreign Application Priority Data
Aug. 27, 2003 (CL) 1740-2003

(51) Int. Cl. F16L 37/28

(52) U.S. Cl. 251/149.6

(57) ABSTRACT

To avoid waste of material and costs originated by retention valves that control the flow of liquid petroleum gas (GLP), wrongly assembled, lower the manufacturing costs, eliminate the potential risks in the security of the valve originated by the user's manipulation when disassembling and reassembling the same, and solving the problems related with the inner adjustment of some parts and the vibrations of the whole, there has been developed a connection rod POL (12) that eliminates the rod's end POL as an independent part by merging both parts in one single part, reducing significantly the normal vibration of the whole. The rod POL (12) includes an end (19) which consists in a concentric circular ring (20) with a plurality of rectangular cuts (21), preferably four and arranged orthogonally, partially surrounding the spring (10), so when the action of the fluid moves the rod POL (12), the ring (20) moves towards the end of the mechanized region (11).

### BACKGROUND OF THE INVENTION

In these days there are retention valves which regulate the flow of liquid petroleum gas (GLP), from product storage tanks, like the existing ones in the industry, residences or the ones installed in public and privet transport vehicles, to discharge hoses of the product connected to different devices.

More particularly, the conventional retention valves are conformed by a group of different internal standardized pieces which conforms a complex integrated whole, which typically includes: a rod guiding member, an O ring seal, a connection rod POL (petroleum, oil & lubricants), a rod's gasket, a rod's washer, and a spring.

One of these retention valves is disclosed in the U.S. Pat. No. 5,330,155, property of Harsco Corporation. In FIG. 1 is depicted a retention valve of the prior art, in which the assembling of the whole begins firstly with the mounting and screwing of the group guiding member—connection rod POL at the end of the mechanized region, that consists in the rod guiding member (1) and the O ring seal (2). Inside this whole is riveted the connection rod POL (3), which has previously mounted on its front the rod's gasket (4) and the rod's washer (5). Between the guiding member (1) and the rod (3) the spring (6) is compressed. The O ring seal (7) fits the rod (3) and the guiding member (1). The rod's gasket (4) seals the washer (5) and the outer / rear region of the guiding member (1). The adjustment gasket (8) is vulcanized against the rear region of the rod and additionally allows the seal with the nipple (9). The whole is mounted with adhesive as an independent unit.

In the assembling process of the different types of retention valves currently used, the different inner pieces are sequentially mounted up to complete the assembling. Once said assemble has been completed it is carried out a security test of the valve, connecting it to a cylinder of GLP and inserting it the nipple for the connection to the hose.

One of the inconvenients of the mentioned model is that during the above described assembling process the connection rod POL must be riveted inside the retention valve, which may produce a detonation resulting in a defective valve which do not pass the initial security test, involving a consequent waste of material and costs.

In the same way, some damages in the parts of the whole, or the lost of any inner part, are produced when the user, in order to make the maintenance or replacing of any part, disassemble and reassemble the whole.

Another common problem in this type of valves may be produced by the rod guiding member POL, that receives the connection rod POL. This rod guiding member POL in some cases may turn axially as the fluid flows making a non desired vibration in the whole, making a consequent wear of the valve and involving the risk of filtrations or breakings in the valve.

In order to avoid waste of material produced by wrongly assembled valves, lower the manufacturing costs, eliminate the potential risks related with the security of the valve originated by the user's manipulation when disassembling and reassembling the same, and solving the problems related with the inner adjustment of some parts and the vibration of the whole, it has been developed a retention valve which has a connection rod POL that eliminates the rod's end POL as an independent part, by merging both parts in one single part, reducing significantly the normal vibration of the whole.

### DESCRIPTION OF THE DRAWINGS

FIG. 1 depicts a schematic view of the valve of the prior art.

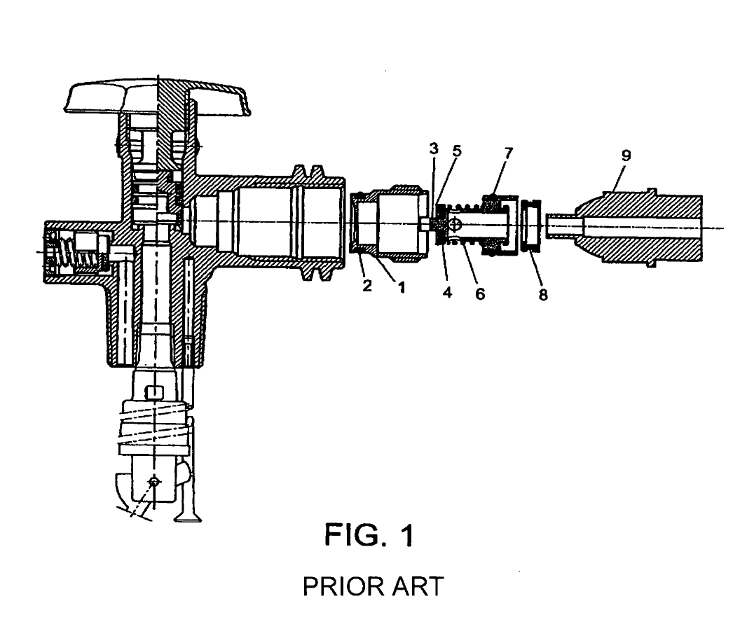

FIG. 2 depicts a schematic view of the present invention.

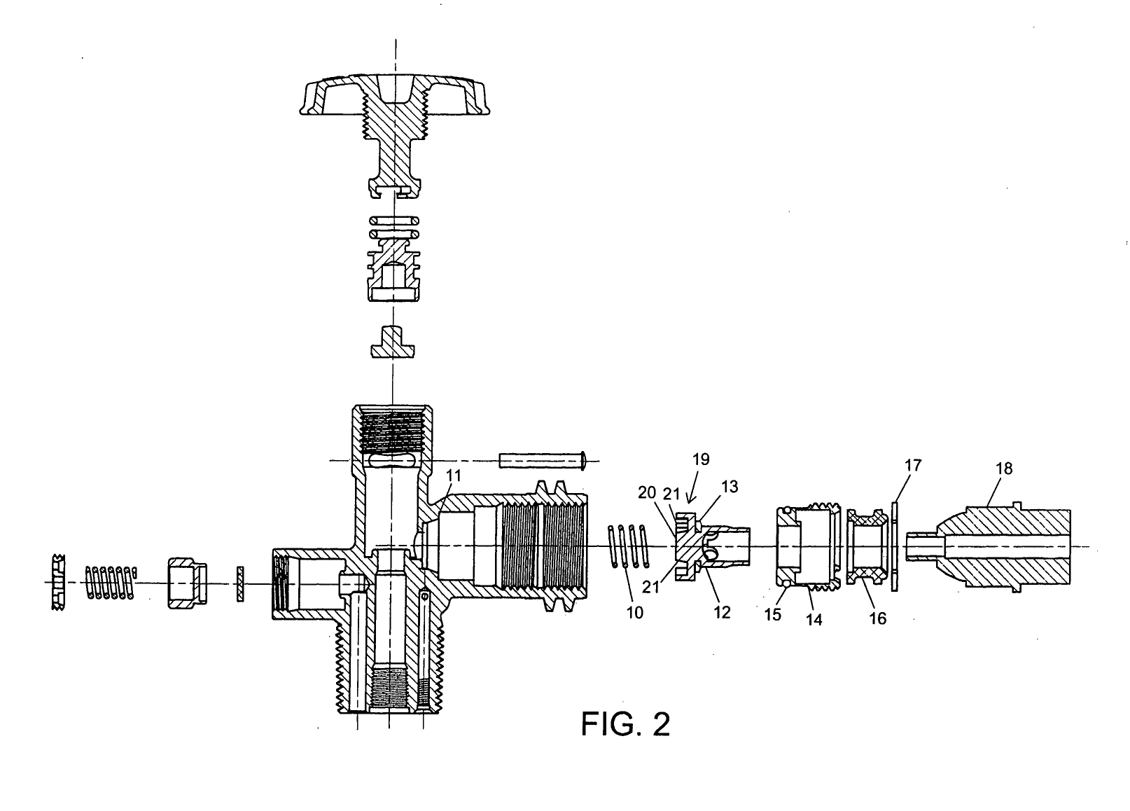

FIG. 3 depicts a perspective view of the present invention with the different parts separated.

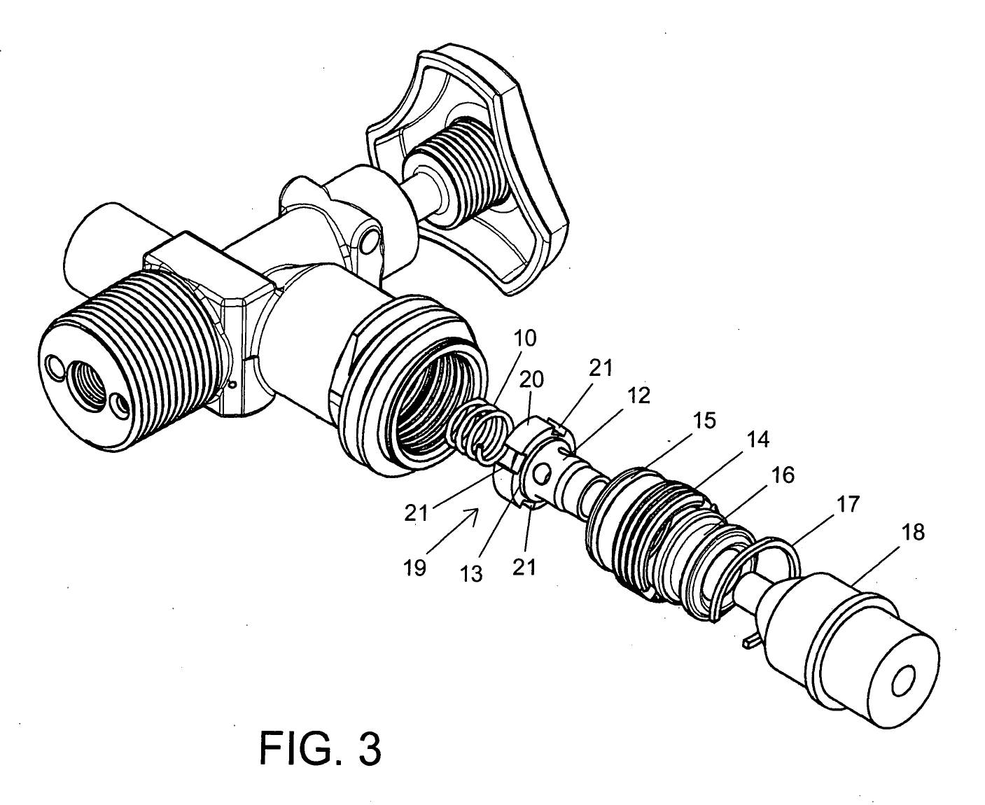

### DESCRIPTION OF THE INVENTION

The present invention consists in a retention valve which controls the emptying of cylinders with liquid petroleum gas.

In accordance with the previous paragraph, the present invention has the objective of providing a retention valve having a rod POL in one single part that eliminates the necessity of riveting during its assembling.

Additionally, another objective of the present invention is providing a rod POL that eliminates the vibrations produced by two separated parts because said rod POL is formed only by one single part.

In an embodiment of the present invention, as it is depicted in the figures attached, the proposed solution consists basically in a spring (10), assembled at the end of the mechanized region (11), that presses a rod POL (12) which has, previously mounted, the rod's gasket (13). Then it is mounted and screwed the group rod guiding member that comprises the rod guiding member (14), an O ring seal (15) and adjustment gasket POL (16). Finally, it is mounted the elastic ring (17), which prevents the whole to be disassembled by user as a safety consideration.

Once concluded the assembling and test of the valve, and when the valve is being used in the cylinder GLP, it is inserted the nipple (18) for the connection to the hose. This nipple (18) may be screwed in the valve by means of an ACME thread or NGO inner thread.

The rod POL (12) includes an end (19) which consists in a concentric circular ring (20) with a plurality of rectangular cuts (21), preferably four rectangular cuts and arranged orthogonally, partially surrounding the spring (10), so when the action of the fluid moves the rod POL (12), the ring (20) moves towards the end of the mechanized region (11).

1. A retention valve for controlling the emptying of cylinders containing liquid petroleum gas comprising a rod having an end which consists of a concentric circular ring with a plurality of cuts, said end of said rod partially surrounding a spring, so when action of fluid in the valve moves the rod, the ring moves towards an end of a mechanized region of the valve, a rod guiding member mounted over the rod and screwed into the end of the mechanized region of the valve, a gasket mounted on the rod between the rod guiding member and the rod, an O ring seal mounted on the rod guiding member for sealing the rod guiding member to the end of the valve when it is screwed into the valve, an adjustment gasket mounted inside the rod guiding member for receiving a nipple and an elastic ring mounted on the rod guiding member.

2. The retention valve according to claim 1, wherein the rod and the ring on the end thereof are one single piece.

3. The retention valve according to claim 1, wherein the cuts are four and are orthogonally arranged.

4. The retention valve according to claim 1, wherein the cuts have a rectangular shape.

5. (canceled)

6. The retention valve according to claim 1, including the nipple for connection to a hose inserted into the rod guiding member and rod.

7. The retention valve according to claim 6, wherein the nipple has ACME threads that can be screwed into the valve.

8. The retention valve according to claim 6, wherein the nipple has NGO inner threads that can be screwed into the valve.
